(19) United States
(12) Patent Application Publication
(10) Pub. No.: US 2015/0029420 A1
(43) Pub. Date: Jan. 29, 2015

(54) TOUCH PANEL

(71) Applicants: Yi-Chun Wu, Hualien County (TW); Yu-Chen Liu, Taipei City (TW); Chi-Yuan Hung, New Taipei City (TW); Sheng-Cheng Wang, Taichung City (TW)

(72) Inventors: Yi-Chun Wu, Hualien County (TW); Yu-Chen Liu, Taipei City (TW); Chi-Yuan Hung, New Taipei City (TW); Sheng-Cheng Wang, Taichung City (TW)

(73) Assignee: WINTEK CORPORATION, Taichung City (TW)

(21) Appl. No.: 14/337,241

(22) Filed: Jul. 22, 2014

(30) Foreign Application Priority Data
Jul. 23, 2013 (TW) 102126316

(51) Int. Cl. G06F 1/16

(52) U.S. Cl. CPC G06F 1/1692
USPC 349/12

(57) ABSTRACT

A touch panel including a substrate, first sensing series and optical matching stacked structures is provided. Each first sensing series includes first sensing pads and bridge structures, and two adjacent first sensing pads are connected along the first direction through one of the bridge structure. Each optical matching stacked structure includes a first optical matching pattern and a second optical matching pattern disposed between the first optical matching pattern and the bridge structure, and the optical matching stacked structures are disposed on a surface of the bridge structures that faces to a user so as to reduce a reflectivity of light along a direction of view in areas where the bridge structures are located.

### CROSS-REFERENCE TO RELATED APPLICATION

This application claims the priority benefit of Taiwan application serial no. 102126316, filed on Jul. 23, 2013. The entirety of the above-mentioned patent application is hereby incorporated by reference herein and made a part of this specification.

### BACKGROUND

1. Technical Field

The invention relates to a touch panel. Particularly, the invention relates to a touch panel capable of decreasing a reflectivity of bridge structures.

2. Related Art

Along with quick development and applications of information technology, wireless mobile communication and information home appliances, in order to achieve effects of portability, small size and user-friendly, input devices of many information products have been changed from conventional keyboard or mice into touch panels.

Taking a capacitive touch panel as an example, the conventional capacitive touch panel includes a substrate and a plurality of first sensing series, a plurality of second sensing series and a plurality of insulating patterns disposed on the substrate. The first sensing series and the second sensing series respectively have different extending direction and are intersected to each other, and the first sensing series and the second sensing series are electrically insulated to each other through the insulating patterns disposed at the intersections thereof.

Generally, each of the first sensing series and each of the second sensing series are respectively composed of a plurality of sensing pads and connection portions, and considering an application range of the touch panel (for example, used in collaboration with a display panel), a material of the sensing pads is generally a transparent conductive material with good light transmittance. Moreover, since the connection portions of the first sensing series and the connection portions of the second sensing series are intersected to each other, the connection portions of one of the first sensing series and the second sensing series are required to be fabricated through a fabrication step different to that of the sensing pads. Generally, the connection portion is composed of a metal bridge with good conductivity, wherein the metal bridge crosses over the insulating pattern, and electrically connects the sensing pads located at two opposite ends of the metal bridge. However, since a reflectivity of the metal bridge is far greater than a reflectivity of the sensing pads made of the transparent conductive material in the first sensing series and the second sensing series (the reflectivity of the metal bridge generally exceeds 50%), a visual effect of the touch panel is influenced.

### SUMMARY

The invention is directed to a touch panel, which has a good visual effect.

The invention provides a touch panel including a substrate, a plurality of first sensing series, a plurality of second sensing series and a plurality of optical matching stacked structures. The first sensing series are disposed on the substrate, and each of the first sensing series extends along a first direction. Each of the first sensing series includes a plurality of first sensing pads and a plurality of bridge structures, and each of the bridge structures connects two adjacent first sensing pads along the first direction. The second sensing series are electrically insulated from the first sensing series and are disposed on the substrate, and each of the second sensing series extends along a second direction, wherein the first direction is intersected to the second direction. Each of the second sensing series includes a plurality of second sensing pads and a plurality of connection portions, and each of the connection portions connects two adjacent second sensing pads along the second direction. The optical matching stacked structures are disposed on a surface of the bridge structures that faces to a user so as to reduce a reflectivity of light along a direction of view in areas where the bridge structures are located, wherein each of the optical matching stacked structures includes a first optical matching pattern and a second optical matching pattern, and the second optical matching pattern is disposed between the first optical matching pattern and the bridge structure.

In an embodiment of the invention, each of the optical matching stacked structures is disposed between the substrate and one of the bridge structures.

In an embodiment of the invention, an extinction coefficient of the first optical matching pattern is k1, a refractive index thereof is n1, and 0.2*n1<k1<2*n1, and an extinction coefficient of the second optical matching pattern is k2, a refractive index thereof is n2, and k2<0.05*n2.

In an embodiment of the invention, the touch panel further includes an insulating layer, and the insulating layer is disposed between the first sensing series and the second sensing series.

In an embodiment of the invention, the bridge structures and the optical matching stacked structures are disposed between the insulating layer and the substrate, and each of the connection portions crosses over the corresponding bridge structure to electrically connect two adjacent second sensing pads.

In an embodiment of the invention, each of the first optical matching patterns is disposed on the substrate, and the second optical matching pattern covers the first optical matching pattern and the substrate. Each of the bridge structures is disposed between the insulating layer and the second optical matching pattern, and each of the connection portions crosses over the corresponding bridge structure to electrically connect two adjacent second sensing pads.

In an embodiment of the invention, the connection portions are disposed between the insulating layer and the substrate, wherein each of the optical matching stacked structures crosses over the corresponding connection portion, and each of the bridge structures covers one of the optical matching stacked structures.

In an embodiment of the invention, the touch panel further includes an extinction layer, and the first sensing series and the second sensing series are disposed between the extinction layer and the substrate.

In an embodiment of the invention, the touch panel further includes an extinction layer, and the first sensing series and the second sensing series are disposed between the extinction layer and the second optical matching patterns.

In an embodiment of the invention, the touch panel further includes an extinction layer covering the substrate, and the extinction layer is disposed between the substrate and the first sensing series and between the substrate and the second sensing series.

In an embodiment of the invention, a sidewall of each of the bridge structures is aligned with a sidewall of the optical matching stacked structure.

In an embodiment of the invention, each of the bridge structures includes a first pattern, and a material of the first panel includes gold, silver, copper, aluminium, chromium, platinum, rhodium, molybdenum, titanium, nickel, indium, tin, or alloys thereof, or at least one of nitride, oxide, nitrogen oxide of the above metals, or the first pattern is a multilayer-stacked conductive layer, and a material of the conductive layer includes at least two of the above materials.

In an embodiment of the invention, each of the bridge structures includes a second pattern, and the second pattern is disposed between the first pattern and the corresponding optical matching stacked structure.

In an embodiment of the invention, an extinction coefficient of the second pattern is the same to the extinction coefficient of the first optical matching pattern, and a refractive index of the second pattern is the same to the refractive index of the first optical matching pattern.

In an embodiment of the invention, each of the bridge structures further includes a third pattern disposed on the first pattern, and the first pattern is disposed between the third pattern and the corresponding optical matching stacked structure.

In an embodiment of the invention, a sidewall of each of the optical matching stacked structures is wrapped by the bridge structure.

In an embodiment of the invention, a light transmittance of each of the optical matching stacked structure is greater than 30%.

In an embodiment of the invention, the reflectivity of light in areas where the bridge structures are located is smaller than 20%.

In an embodiment of the invention, when a film thickness of each of the first optical matching pattern is between 140 Å and 160 Å, and a film thickness of each of the second optical matching pattern is between 480 Å and 520 Å, the reflectivity of light in areas where the bridge structures are located is smaller than 10%.

In an embodiment of the invention, each of the first sensing pads is disposed between one of the optical matching stacked structures and the substrate.

In an embodiment of the invention, a sidewall of each of the bridge structures is covered and contacted by the corresponding first sensing pads.

In an embodiment of the invention, a light transmittance of each of the optical matching stacked structures is greater than a light transmittance of each of the bridge structures.

In an embodiment of the invention, a material of the first sensing pad and the second sensing series includes indium tin oxide, indium zinc oxide, aluminium tin oxide, aluminium zinc oxide or indium germanium zinc oxide, or the first sensing pad and the second sensing series are respectively composed of metal mesh, or the first sensing pad and the second sensing series are respectively a multilayer-stacked conductive layer, and a material of the conductive layer includes at least two of indium tin oxide, indium zinc oxide, aluminium tin oxide, aluminium zinc oxide, indium germanium zinc oxide and metal mesh.

In an embodiment of the invention, each of the first sensing pads and each of the second sensing series are respectively composed of metal mesh, and the optical matching stacked structures are further disposed on a surface of the first sensing pads and the second sensing series that faces to the user.

In an embodiment of the invention, the substrate has a touch area and a periphery area located to at least one side of the touch area, and the touch panel further includes a decoration layer, and the decoration layer is located in the periphery area.

In an embodiment of the invention, the decoration layer is located on the substrate at a side the same to that of the first sensing series and the sensing series.

In an embodiment of the invention, the decoration layer is located on the substrate at a side opposite to that of the first sensing series and the sensing series.

In an embodiment of the invention, the touch panel further includes a carrier board, wherein the carrier board is located on the substrate at a side opposite to that of the first sensing series and the sensing series, and the decoration layer is disposed on the carrier board, and is disposed between the substrate and the carrier board, wherein an orthogonal projection of the decoration layer on the substrate is disposed in the periphery area.

In an embodiment of the invention, the substrate is a color filter substrate, an array substrate or a package cover of an organic light-emitting display (OLED).

According to the above descriptions, in the touch panel of the invention, the optical matching stacked structures are disposed at areas corresponding to the bridge structures, and the optical parameters (including the extinction coefficients and the refractive indexes) of the optical matching stacked structures are designed to mitigate the problem of a high reflectivity of light in areas where the bridge structures are located. In this way, when the light irradiates the touch panel, the reflectivity of light in areas where the bridge structures are located is greatly decreased. Therefore, the touch panel may have better visual effect, i.e. the user is not easy to perceive a profile of the bridge structures.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial top view of a touch panel according to a first embodiment of the invention.

FIG. 2A and FIG. 2B are respectively cross-sectional views of the touch panel of FIG. 1 along a section line A-A′ and a section line B-B′.

FIG. 3A and FIG. 3B are cross-sectional views of a touch panel according to a second embodiment of the invention.

FIG. 4A and FIG. 4B are cross-sectional view of a touch panel according to a third embodiment of the invention.

FIG. 5A and FIG. 5B are cross-sectional views of a touch panel according to a fourth embodiment of the invention.

FIG. 6 is a partial top view of a touch panel according to a fifth embodiment of the invention.

FIG. 7A and FIG. 7B are respectively cross-sectional view of the touch panel of FIG. 6 along a section line C-C′ and a section line D-D′.

FIG. 8A and FIG. 8B are cross-sectional views of a touch panel according to a sixth embodiment of the invention.

FIG. 9A and FIG. 9B are cross-sectional views of a touch panel according to a seventh embodiment of the invention.

FIG. 10A and FIG. 10B are cross-sectional views of a touch panel according to an eighth embodiment of the invention.

FIG. 11 is a partial top view of a touch panel according to a ninth embodiment of the invention.

### DETAILED DESCRIPTION OF DISCLOSED EMBODIMENTS

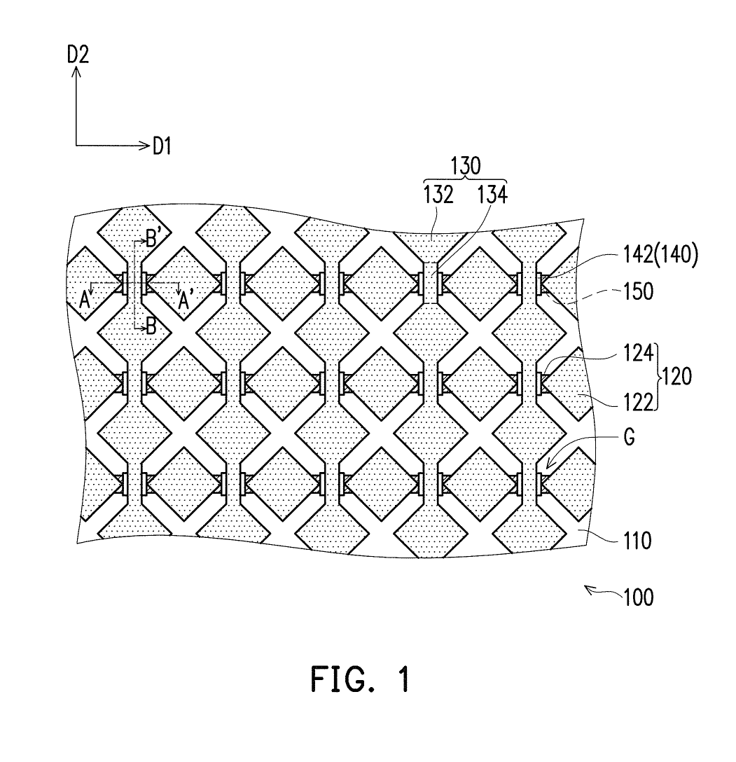

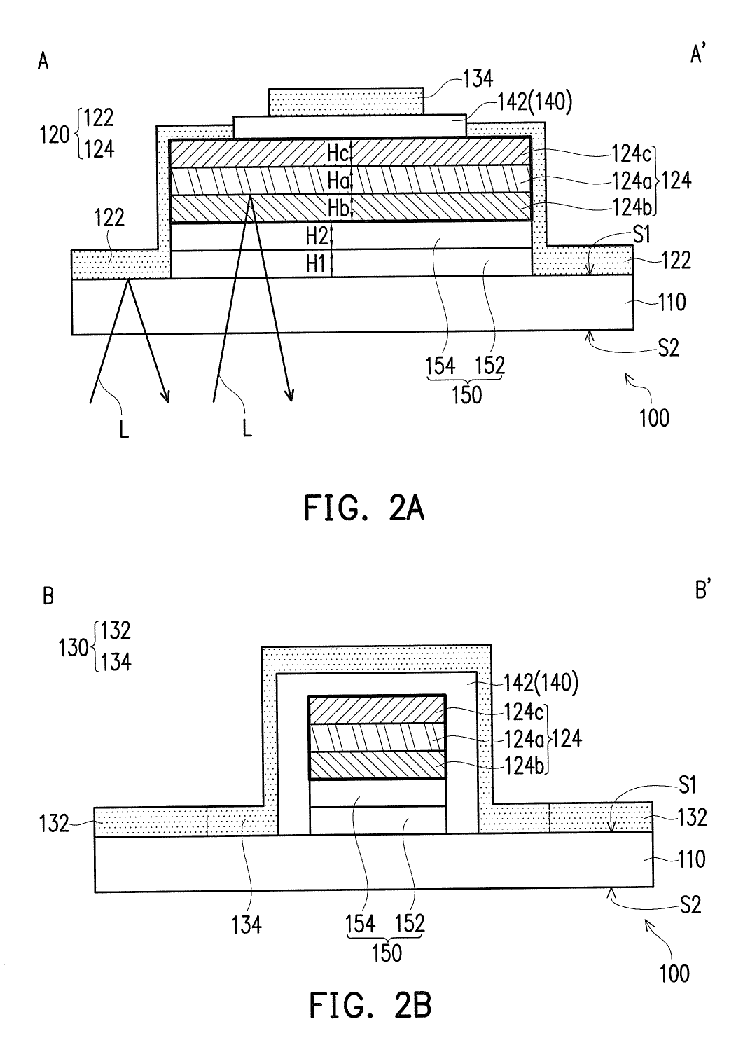

FIG. 1 is a partial top view of a touch panel according to a first embodiment of the invention. FIG. 2A and FIG. 2B are respectively cross-sectional views of the touch panel of FIG. 1 along a section line A-A′ and a section line B-B′. Referring to FIG. 1, taking a capacitive touch panel as an example, the touch panel 100 of the present embodiment includes a substrate 110, a plurality of first sensing series 120, a plurality of second sensing series 130 and a plurality of optical matching stacked structures 150.

The substrate 110 is used for carrying the first sensing series 120, the second sensing series 130 and the optical matching stacked structures 150. In the present embodiment, the first sensing series 120, the second sensing series 130 and the optical matching stacked structures 150 are, for example, disposed on a same surface S1 of the substrate 110. Moreover, a material of the substrate 110 can be glass, sapphire glass, polyethylene terephthalate (PET), polymethylmethacrylate (PMMA), propylene carbonate (PC), cellulose triacetate (TAC) or a combination thereof.

The first sensing series 120 disposed on the substrate 110 respectively extend along a first direction D1 and are electrically insulated to each other. Moreover, the second sensing series 130 disposed on the substrate 110 respectively extend along a second direction D2 and are electrically insulated to each other, wherein the first direction D1 is intersected to the second direction D2. In the present embodiment, the first direction D1 is, for example, perpendicular to the second direction D2, though the invention is not limited thereto.

Each of the first sensing series 120 includes a plurality of first sensing pads 122 and a plurality of bridge structures 124, and each of the bridge structures 124 connects two adjacent first sensing pads 120 along the first direction D1. Moreover, each of the second sensing series 130 includes a plurality of second sensing pads 132 and a plurality of connection portions 134, and each of the connection portions 134 connects two adjacent second sensing pads 132 along the second direction D2. In the present embodiment, each of the connection portions 134 is, for example, intersected to one of the bridge structures 124.

Moreover, the touch panel 100 may further include an insulating layer 140, and the insulating layer 140 is disposed between the first sensing series 120 and the second sensing series 130 to electrically insulate the first sensing series 120 and the second sensing series 130. In detail, the insulating layer 140 of the present embodiment, for example, includes a plurality of island-like insulating structures 142, and the insulating structures 142 are respectively disposed between each of the bridge structures 124 and the corresponding connection portion 134 intersected to each other, thought the shape of the insulating layer 140 is not limited by the invention. In other embodiments, the insulating layer 140 can also be a bar-shaped insulating structure, or fully covers a touch area (i.e. an area where the first sensing series 120 and the second sensing series 130 locate), or even extends out of the touch area according to a design requirement. Moreover, a material of the insulating layer 140 is, for example, an organic material or a transparent photoresistor, and a refractive index thereof is within a range of 1.5-1.9, and a film thickness thereof is within a range of 1 μm-2 μm.

Referring to FIG. 1, FIG. 2A and FIG. 2B, in the present embodiment, a sequence of forming the first sensing series 120, the second sensing series 130, the insulating layer 140 and the optical matching stacked structures 150 on the substrate 110 is as follows. First, the optical matching stacked structures 150 are formed. Then, the bridge structures 124 of the first sensing series 120 are formed. Then, the insulating layer 140 is formed. Thereafter, the first sensing pads 122 of the first sensing series 120 and the second sensing series 130 are formed.

In other words, the first sensing pads 122 of the first sensing series 120 and the second sensing pads 132 and the connection portions 134 of the second sensing series can be formed simultaneously and may have a same material, and the second sensing pads 132 and the connection portions 134 of the second sensing series 130 are, for example, formed integrally. In the present embodiment, a material of the first sensing pads 122 and the second sensing series 130 is, for example, a metal oxide such as indium tin oxide, indium zinc oxide, aluminium tin oxide, aluminium zinc oxide or indium germanium zinc oxide or other suitable oxides. However, in other embodiments, the material of the first sensing pads 122 and the second sensing series 130 can be respectively composed of metal mesh. Alternatively, the first sensing pad 122 and the second sensing series 130 are respectively a multilayer-stacked conductive layer, and a material of the conductive layer includes at least two of the indium tin oxide, the indium zinc oxide, the aluminium tin oxide, the aluminium zinc oxide and the indium germanium zinc oxide.

On the other hand, the bridge structures 124 of the first sensing series 120 are not formed simultaneously with the first sensing pads 122 and the second sensing series 130, and a material of the bridge structure is different to the material of the first sensing pad 122. For example, each of the bridge structures 124 of the present embodiment includes a first pattern 124a, wherein a material of the first pattern 124a is, for example, gold, silver, copper, aluminium, chromium, platinum, rhodium, molybdenum, titanium, nickel, indium, tin, or alloys thereof, or at least one of nitride, oxide, nitrogen oxide of the above metals. Alternatively, the first pattern 124a can be a multilayer-stacked conductive layer, and a material of the conductive layer includes at least two of the above materials. Moreover, considering a sensing sensitivity of the touch panel 100, a film thickness Ha of the first pattern 124a is, for example, greater than 1000 Å to maintain certain conductivity.

Each of the optical matching stacked structures is disposed on a surface of the bridge structure 124 that faces to a user. In the present embodiment, a surface S2 of the substrate 110 opposite the surface S1 that carries the components is, for example, a touch surface. In other words, when the user operates the touch panel 110, the user is located at one side of the substrate 110 close to the surface S2. Therefore, the optical matching stacked structure 150 of the present embodiment is, for example, disposed between the substrate 110 and the corresponding bridge structure 124, though the invention is not limited thereto. In other embodiments, when the surface S1 is the touch surface, the bridge structure 124 is disposed between the substrate 110 and the corresponding optical matching stacked structure 150.

Further, each of the optical matching stacked structure 150 includes a first optical matching pattern 152 and a second optical matching pattern 154, and the second optical matching pattern 154 is disposed between the first optical matching pattern 152 and the bridge structure 124, wherein the first optical matching pattern 152 and the second optical matching pattern 154 substantially have a same profile, and the optical matching stacked structure 150 and the bridge structure 124 (the first pattern 124a) substantially have a same profile. In detail, a sidewall of the first pattern 124a of each of the bridge structures 124 is, for example, aligned with sidewalls of the first optical matching pattern 152 and the second optical matching pattern 154.

In the present embodiment, the bridge structures 124 and the optical matching stacked structures 150 are disposed between the insulating layer 140 and the substrate 110, and each of the connection portions 134 crosses over the corresponding bridge structure 124 to electrically connect two adjacent second sensing pads 132. Moreover, sidewalls of each of the bridge structures 124 and the optical matching stacked structure 150 are covered and contacted by the corresponding first sensing pad 122 (shown in FIG. 2A), and a sidewall of each of the insulating layer 140 is covered and contacted by the corresponding connection portion 134 (shown in FIG. 2B).

In the conventional technique, a metal material is used to fabricate a bridge structure connecting two adjacent pads, and such metal bridge structure is also referred to as a metal bridge. A reflectivity of the metal bridge is high, which results in a fact that most of the light is reflected at the metal bridge, so that the touch panel has a poor visual effect (for example, bright spots are viewed at the areas where the metal bridges are located). Therefore, in the present embodiment, by disposing the optical matching stacked structure 150 at a side of the bridge structure 124 facing to the user, and matching reflectivity and extinction coefficients of the first pattern 124a and the optical matching stacked structure 150, the reflectivity of the areas where the first patterns 124a (the bridge structures 124) are located is decreased.

In detail, since the first pattern 124a has a lower light transmittance, and a light transmittance of the optical matching stacked structure 150 is greater than that of the first pattern 124a, when light L irradiates the first sensing series 120 through the substrate 110, the light L penetrates through the optical matching stacked structure 150 and irradiates the first pattern 124a. Namely, the optical matching stacked structure 150 is not a member intentionally used to block the light L, but is a member that is pervious to the light L. For example, the light transmittance of the optical matching stacked structure is, for example, greater than 30%. Moreover, since the first pattern 124a may provide a reflection surface, the light L is not easy to pass through the first pattern 124a. Namely, when the light L irradiates the first pattern 124a, the light L is liable to be blocked by the first pattern 124a. Therefore, reflection of the light L caused by the film layers above the first pattern 124a is unnecessary to be considered, and only the reflectivity of the optical matching stacked structure 150 disposed between the substrate 110 and the first pattern 124a is considered to determine the visual effect of the areas where the bridge structures 124 are located.

In the present embodiment, an extinction coefficient of the first optical matching pattern 152 is k1, a refractive index thereof is n1, and 0.2*n1<k1<2*n1, and an extinction coefficient of the second optical matching pattern 154 is k2, a refractive index thereof is n2, and k2<0.05*n2. Therefore, when the light L irradiates the touch panel 100, the reflectivity of the light L at the areas where the bridge structures 124 are located is decreased, and the reflectivity of the light L at the areas where the bridge structures 124 are located is smaller than 20%. In an embodiment, when a film thickness H1 of each of the first optical matching patterns 152 is between 140 Å and 160 Å, a film thickness H2 of each of the second optical matching patterns 154 is between 480 Å and 520 Å, and the reflectivity of the light L in areas where the bridge structures are located can be further decreased to be smaller than 10%.

A material of the first optical matching pattern 152 is, for example, gold, silver, copper, aluminium, chromium, platinum, rhodium, molybdenum, titanium, nickel, indium, tin, or alloys thereof, or at least one of nitride, oxide, nitrogen oxide of the above metals, or the first optical matching pattern 152 can also be a multilayer-stacked conductive layer, and a material of the conductive layer includes at least two of the above materials. Moreover, a material of the second optical matching pattern 154 is, for example, a metal oxide, SiOₓ, SiNₓ, SiNOₓ or a mixture of at least two of the above materials. The metal oxide can be TiOₓ, Ta₂O₅, Nb₂Oₓ, Al₂O₃, indium tin oxide (ITO), indium zinc oxide (IZO), aluminium tin oxide (ATO), aluminium zinc oxide (AZO), and indium germanium zinc oxide (IGZO) or a combination thereof.

Since the optical matching stacked structure 150 of the present embodiment may decrease the reflectivity of the light L at the areas where the bridge structures 124 are located through a double layer structure (a double layer structure formed by the first optical matching pattern 152 and the second optical matching pattern 154 stacked to each other), compared to the existing technique that at least four layers of optical films with high and low reflective indexes are stacked in alternation to decrease the reflectivity of the light at the areas where the metal structures are located, the time required for fabricating the optical matching stacked structure 150 of the present embodiment can be decreased, and complexity of the fabrication process is simplified.

Moreover, the optical matching stacked structure 150 of the present embodiment adopts an optical matching manner (referred to a design of the extinction coefficient and reflective index) to decrease the reflectivity of the light L at the areas where the bridge structures 124 are located other than the conventional light shielding manner. Therefore, regarding the touch panel 100 of the present embodiment, not only the reflectivity is decreased to improve the visual effect, product aesthetics is also considered.

In the present embodiment, each of the bridge structures 124 may further include a second pattern 124b and a third pattern 124c, wherein the first pattern 124a is disposed between the second pattern 124b and the third pattern 124c. In detail, the second pattern 124b is disposed between the first pattern 124a and the corresponding optical matching stacked structure 150, the third pattern 124c is disposed on the first pattern 124a, and the first pattern 124a is disposed between the third pattern 124c and the corresponding optical matching stacked structure 150.

The second pattern 124b can be used for protecting the first pattern 124a and increasing a structural strength of the bridge structure 124, and can also be used for increase adhesion between the first pattern 124a and the corresponding optical matching stacked structure 150. In an embodiment, when an extinction coefficient of the second pattern 124b is the same to an extinction coefficient of the first optical matching pattern 152, and a refractive index of the second pattern 124b is the same with a refractive index of the first optical matching pattern 152, the second pattern 124b may have an optical matching effect. In this way, the reflectivity of the light L at the areas where the bridge structures 124 are located can be further decreased to increase the visual effect of the touch panel 100.

On the other hand, the third pattern 124c can also be used for protecting the first pattern 124a, increasing a structural strength of the bridge structure 124 and to avoid oxidation of the first pattern 124a. Moreover, the third pattern 124c can be further used for increasing the adhesion between the first pattern 124a and the insulating layer 140. Therefore, the third pattern 124c may select a material with a better adhesion effect, for example, a material the same with that of the second pattern 124b. Furthermore, film thickness Hb and Hc of the second pattern 124b and the third pattern 124c are, for example, smaller than 1000 Å.

It should be noticed that although the first sensing pads 122 and the second sensing series 130 made of the metal oxide are taken as an example for descriptions, the invention is not limited thereto. In an embodiment, when the first sensing pads 122 and the second sensing series 130 are respectively composed of metal mesh, or composed of a material the same to that of the bridge structure 124, the optical matching stacked structure 150 can be further located on the surface of the first sensing pads 122 and the second sensing series 130 that faces to the user (i.e. located between the user and the first sensing pads and the second sensing series) to decrease the reflectivity of the touch panel.

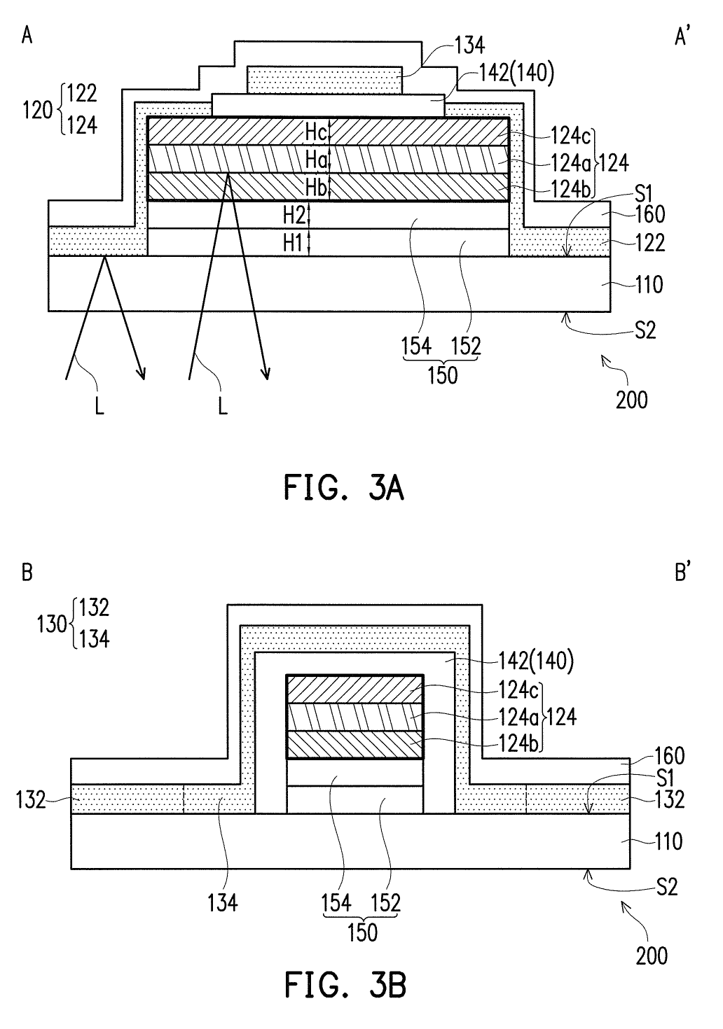

On the other hand, besides that the bridge structure 124 influences the visual effect of the touch panel 100, the first sensing series 120 and the second sensing series 130 may also influence the visual effect of the touch panel 100. FIG. 3A and FIG. 3B are cross-sectional views of a touch panel according to a second embodiment of the invention. Referring to FIG. 3A and FIG. 3B, the touch panel 200 of the present embodiment further has an extinction layer 160 based on the structure of the touch panel 100 of FIG. 2A and FIG. 2B, wherein the extinction layer 160, for example, fully covers a touch area (i.e. the area where the first sensing series 120 and the second sensing series 130 are located) of the touch panel 200, and the first sensing series 120 and the second sensing series 130 are disposed between the extinction layer 160 and the substrate 110, though the invention is not limited thereto. For example, in other embodiments, the extinction layer 160 can also cover the substrate 110, and is disposed between the substrate 110 and the first sensing series 120 and between the substrate 110 and the second sensing series 130. Moreover, a material of the extinction layer 160 can be a general insulating material such as silicon oxide, silicon nitride, silicon oxynitride, silicon aluminium oxide or a combination thereof.

By configuring the extinction layer 160, a difference between reflectivity of the light L at a gap G (referring to FIG. 1) between the sensing pads (including the first sensing pads 122 and the second sensing pads 132) and reflectivity of the light L at the sensing series (the first sensing series 120 and the second sensing series 130) can be compensated. In this way, visibility of the first sensing series 120 and the second sensing series 130 can be decreased to improve the visual effect of the touch panel 200.

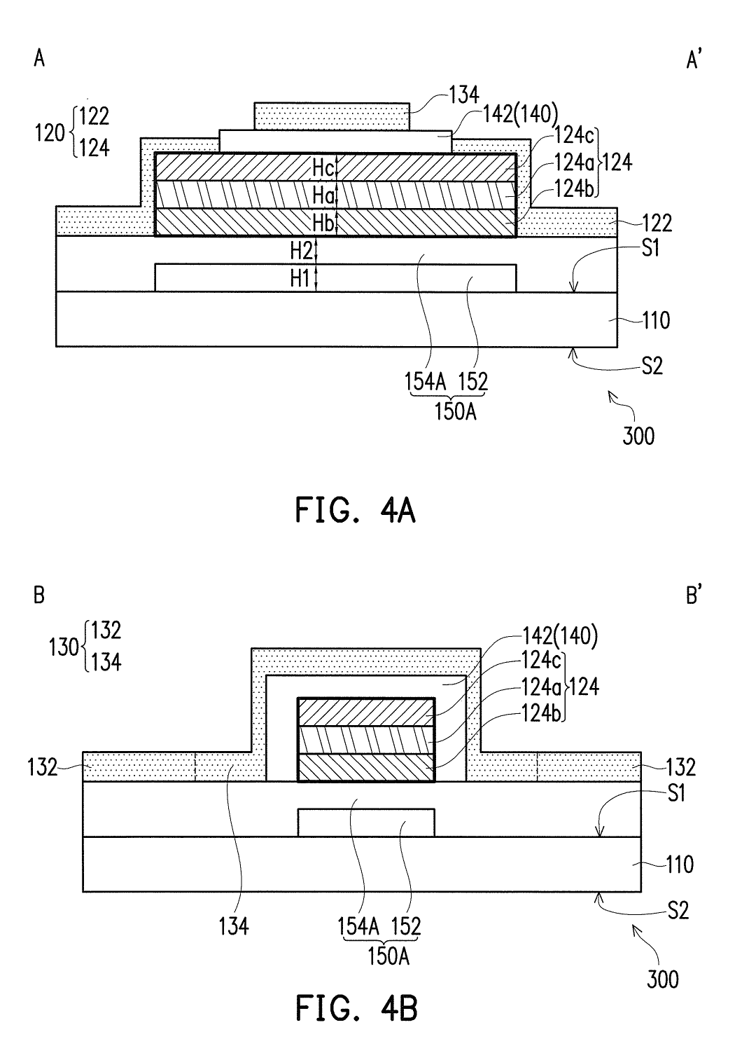

In the aforementioned first and second embodiments, the sidewall of each of the bridge structures 124 is aligned to the sidewall of the first optical matching pattern 152 and the sidewall of the second optical matching pattern 154, though the invention is not limited thereto. FIG. 4A and FIG. 4B are cross-sectional view of a touch panel according to a third embodiment of the invention. The touch panel 300 of the present embodiment has film layers similar to that of the touch panel 100 of FIG. 2A and FIG. 2B, and the similar film layers have similar effects, which is not repeated. Different to the touch panel 100, the first optical matching patterns 152 of the optical matching stacked structures 150A of the touch panel 300 of the present embodiment are disposed on the substrate 110, and the second optical matching patterns 154A cover the first optical matching patterns 152 and the substrate 110.

In detail, the first sensing series 120 (including the first sensing pads 122 and the bridge structures 124) and the second sensing series 130 (including the second sensing pads 132 and the connection portions 134) are disposed on the second optical matching pattern 154A, and the first sensing pads 122 and the second sensing series 130 are structurally separated from the substrate 110, i.e. the first sensing pads 122 and the second sensing series 130 of the present embodiment are not physically contacted to the substrate 110. Moreover, each of the bridge structures 124 is disposed above the corresponding first optical matching pattern 152. In addition, the first optical matching pattern 152 and the bridge structure 124 of the present embodiment substantially have a same profile. In detail, the sidewall of each first optical matching pattern 152 of the present embodiment is, for example, aligned to the sidewall of the corresponding bridge structure 124.

By disposing the optical matching stacked structure 150A on the surface of the bridge structure 124 facing to the user (for example, between the substrate 110 and the bridge structure 124), and through the design of the optical matching constants (the extinction coefficient and the refractive index) of the aforementioned embodiments, the reflectivity of the light L at the areas where the bridge structures 124 are located is decreased, such that when the light L irradiates the touch panel 300, the reflectivity of the light L at the areas where the bridge structures 124 are located is greatly decreased. Therefore, the touch panel 300 has a good visual effect.

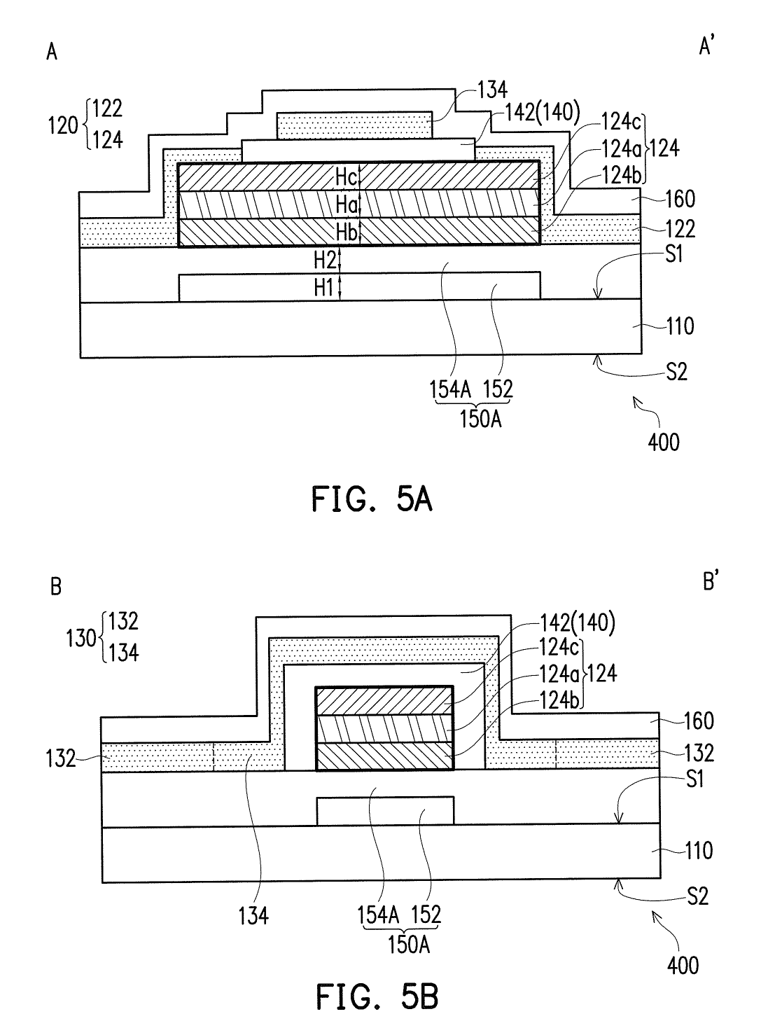

FIG. 5A and FIG. 5B are cross-sectional views of a touch panel according to a fourth embodiment of the invention. Referring to FIG. 5A and FIG. 5B, based on the structure of the touch panel 300 of FIG. 3A and FIG. 4B, an extinction layer 160 is further fabricated, wherein the extinction layer 160, for example, fully covers a touch area (i.e. the area where the first sensing series 120 and the second sensing series 130 are located) of the touch panel 400, and the first sensing series 120 and the second sensing series 130 are disposed between the extinction layer 160 and the substrate 110, though the invention is not limited thereto. For example, in other embodiments, the extinction layer 160 can also cover the substrate 110, and is disposed between the substrate 110 and the first sensing series 120 and between the substrate 110 and the second sensing series 130.

By configuring the extinction layer 160, a difference between reflectivity of the light L at a gap G (referring to FIG. 1) between the sensing pads (including the first sensing pads 122 and the second sensing pads 132) and reflectivity of the light L at the sensing series (the first sensing series 120 and the second sensing series 130) can be compensated. In this way, visibility of the first sensing series 120 and the second sensing series 130 can be decreased to improve the visual effect of the touch panel 200.

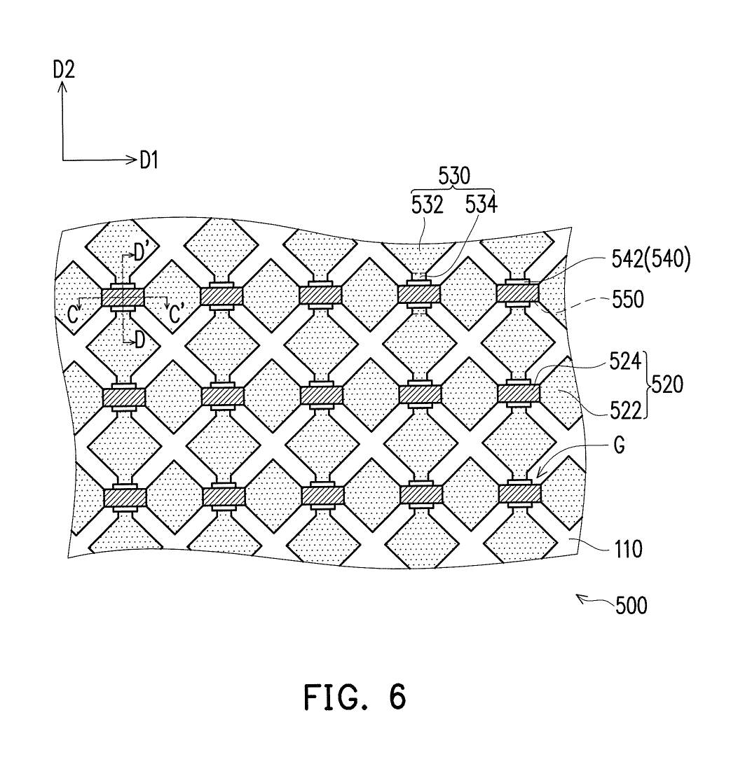

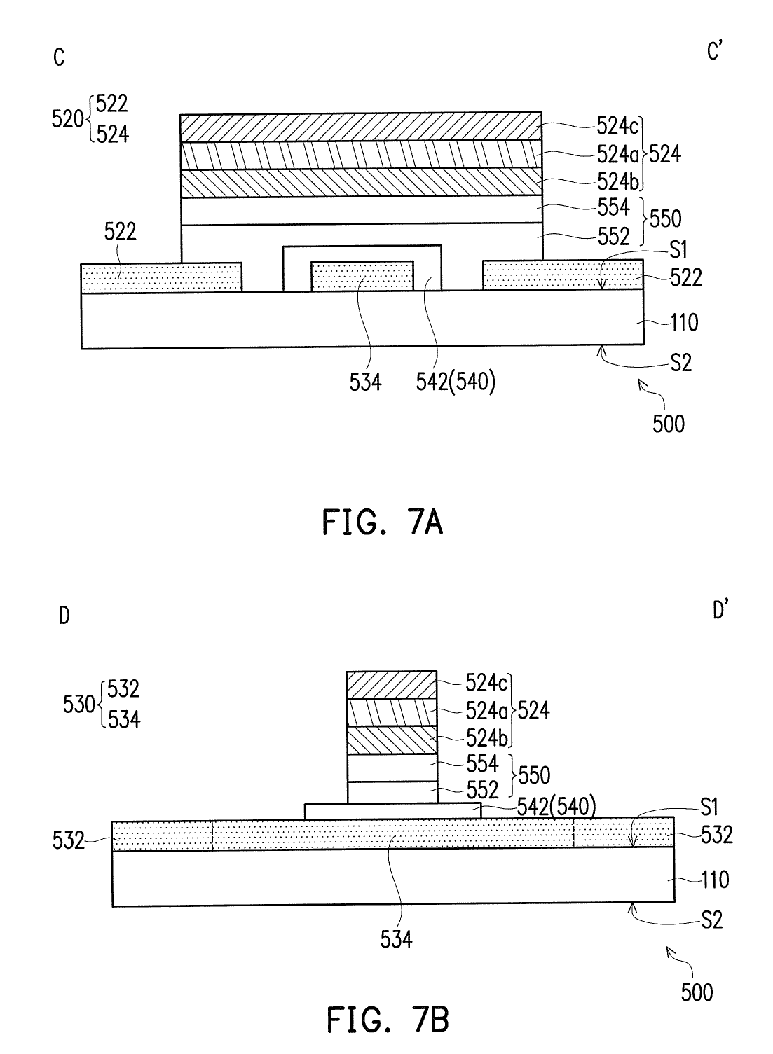

FIG. 6 is a partial top view of a touch panel according to a fifth embodiment of the invention. FIG. 7A and FIG. 7B are respectively cross-sectional view of the touch panel of FIG. 6 along a section line C-C′ and a section line D-D′. Referring to FIG. 6, FIG. 7A and FIG. 7B, the touch panel 500 of the present embodiment has similar film layers, similar materials and similar effects with that of the touch panel 100, and a main difference there between lies in a forming sequence of the first sensing series 520, the second sensing series 530, the insulating layers 540 and the optical matching stacked structures 550 of the touch panel 500. First, the first sensing pads 522 of the first sensing series 520 and the second sensing series 530 are formed. Then, the insulating layers 540 (including a plurality of insulating structures 542) are formed. Thereafter, the optical matching stacked structures 550 are formed. Then, the bridge structures 524 of the first sensing series 520 are formed. Materials and structures of the first sensing series 520, the second sensing series 530, the insulating layers 540 and the optical matching stacked structures 550 may refer to the materials and structures of the first sensing series 120, the second sensing series 130, the insulating layers 140 and the optical matching stacked structures 150 of the aforementioned touch panel 100, which are not repeated.

Different to the touch panel 100, the connection portions 534 of the present embodiment are disposed between the insulating structures 540 and the substrate 110, wherein each of the optical matching stacked structures 550 crosses over the corresponding connection portion 534, and each of the bridge structures 524 is disposed on the corresponding optical matching stacked structure 550 to electrically connect two adjacent first sensing pads 522. Namely, a part region of each connection portion 534 is covered by the corresponding bridge structure 524 (shown in FIG. 7B), and a part region of the first sensing pad 522 is disposed between the optical matching pattern 524b of each bridge structure 524 and the substrate 110 (shown in FIG. 7A).

Moreover, each of the optical matching stacked structure 550 and the bridge structure 524 of the present embodiment substantially have a same profile. In detail, a sidewall of each bridge structure 524 is aligned to a sidewall of the optical matching stacked structure 550. In the present embodiment, each of the bridge structures 524 electrically connects two adjacent first sensing pads 522 through the corresponding optical matching stacked structure 550, so that a material of the optical matching stacked structure 550 is a conductive material. In detail, the material of the first optical matching pattern 552 of the optical matching stacked structure 550 is, for example, the same to the material of the aforementioned first optical matching pattern 152 and the first pattern 124a, and the material of the second optical matching pattern 554 is a conductive material, for example, metal oxide selected from the materials of the second optical matching pattern 154.

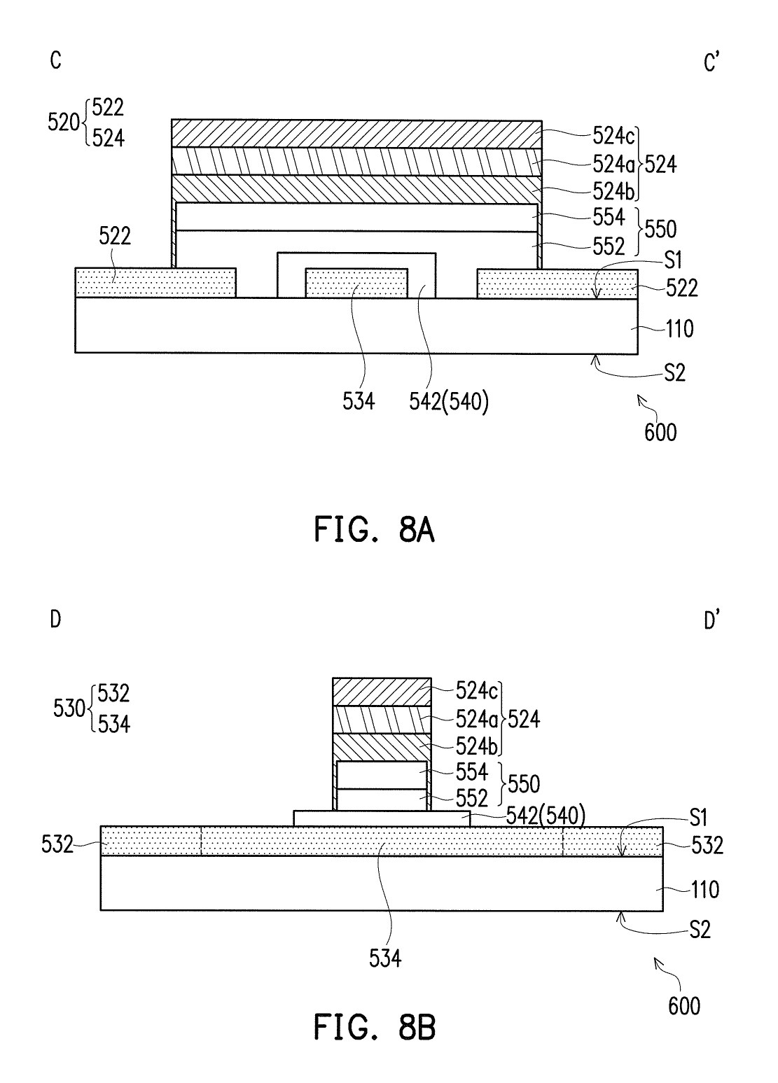

However, each of the optical matching stacked structure 550 is not limited to substantially have the same profile with that of the bridge structure 524. FIG. 8A and FIG. 8B are cross-sectional views of a touch panel according to a sixth embodiment of the invention. Referring to FIG. 8A and FIG. 8B, the sidewall of each of the optical matching stacked structures 550 is, for example, wrapped by a part of the bridge structure 524. In this way, each of the bridge structures 524 may directly contact the two adjacent first sensing pads 522 without electrically connecting the two adjacent first sensing pads 522 through the optical matching stacked structure 550. Therefore, in the embodiment of FIG. 8A and FIG. 8B, the material of the optical matching stacked structure of the touch panel 600 can be the same with that of the optical matching stacked structure 150 of FIG. 1. Namely, a material of the second optical matching pattern 554 can be metal oxide, SiOₓ, SiNₓ, SiNOₓ or a mixture of at least two of the above materials.

In the embodiments of FIG. 7A, FIG. 7B, FIG. 8A and FIG. 8B, through configuration of the optical matching stacked structure 550, and through the design of the optical parameters (the extinction coefficient and the refractive index) of the optical matching stacked structure 550 of the aforementioned embodiments, the reflectivity of the light L at the areas where the bridge structures 524 are located can be smaller than 20%. Namely, by matching the refractive indexes of the bridge structures 524 and the optical matching stacked structures 550, the reflectivity of the light L at the areas where the bridge structures 524 are located is decreased, and when the light L irradiates the touch panels 500 and 600, the reflectivity of the light L at the areas where the bridge structures 524 are located is greatly decreased. In this way, the touch panels 500 and 600 may have a good visual effect.

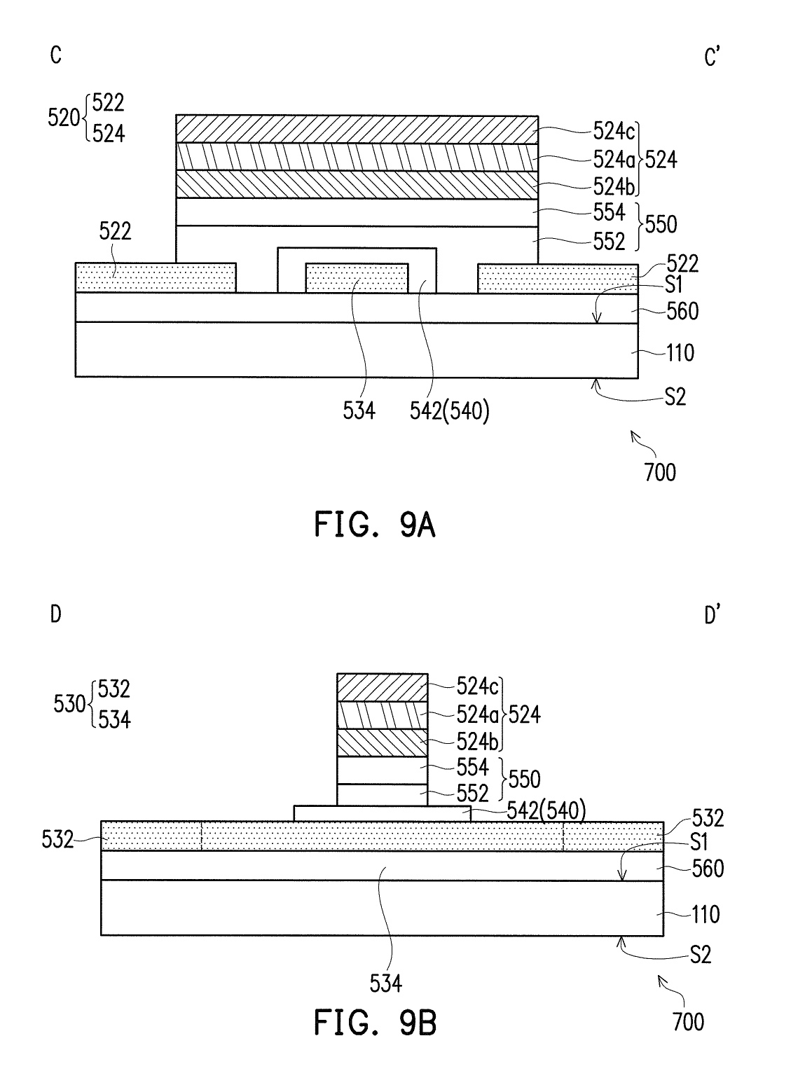

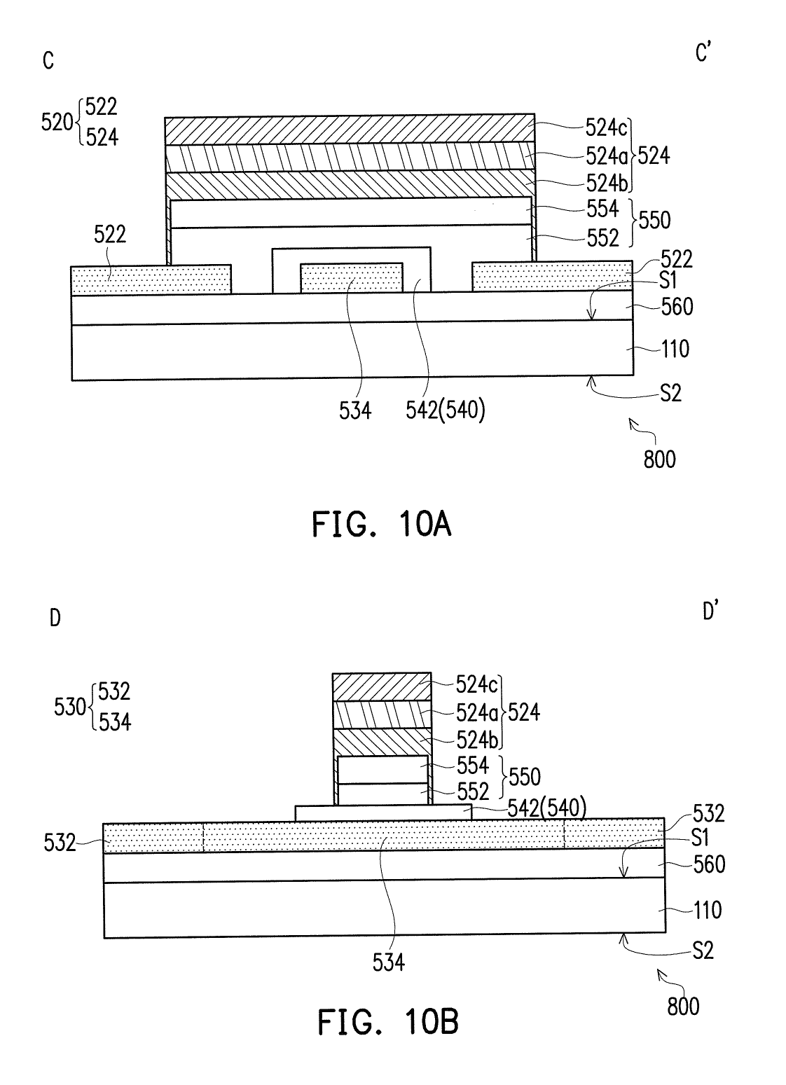

FIG. 9A and FIG. 9B are cross-sectional views of a touch panel according to a seventh embodiment of the invention. FIG. 10A and FIG. 10B are cross-sectional views of a touch panel according to an eighth embodiment of the invention. Referring to FIG. 9A to FIG. 10B, in the embodiments of FIG. 9A, FIG. 9B, FIG. 10A and FIG. 10B, an extinction layer 560 can be further fabricated based on the structures of the touch panels 500 and 600 of FIG. 7A, FIG. 7B, FIG. 8A and FIG. 8B, wherein the extinction layer 560 is, for example, disposed between the substrate 110 and the first sensing series 520 (including the first sensing pads 522 and the bridge structures 524) and between the substrate 110 and the second sensing series 530 (including the second sensing pads 532 and the connection portions 534), though the invention is not limited thereto. For example, in other embodiments, the extinction layer 560 can also fully cover a touch area (i.e. the area where the first sensing series 520 and the second sensing series 530 are located) of the touch panels 700 and 800, and the first sensing series 520 and the second sensing series 530 are disposed between the extinction layer 560 and the substrate 110.

By configuring the extinction layer 560, a difference between reflectivity of the light L at a gap G (referring to FIG. 6) between the sensing pads (including the first sensing pads 522 and the second sensing pads 532) and reflectivity of the light L at the sensing series (the first sensing series 520 and the second sensing series 530) can be compensated. In this way, visibility of the first sensing series 520 and the second sensing series 530 can be decreased to improve the visual effect of the touch panels 700 and 800.

It should be noticed that in the aforementioned first to eighth embodiments, although the surface S2 of the substrate 110 opposite to the device configuring surface (i.e. the surface S1) is taken as the touch surface, and the optical matching stacked structures 150 and 550 are disposed between the substrate 110 and the bridge structures 124 and 524, the invention is not limited thereto. In other embodiments, when the surface S1 of the substrate 110 that is configured with the sensing series (including the first sensing series and the second sensing series) is the touch surface, the bridge structures are, for example, disposed between the optical matching stacked structures and the substrate 110, i.e. the optical matching stacked structures are disposed on the surface of the bridge structures that faces to the user.

For example, the substrate 110 of the touch panels 100, 200, 300, 400, 500, 600, 700 and 800 can be a substrate of a display panel, for example, a color filter substrate, an array substrate or a package cover of an organic light-emitting display. By integrating the touch panels 100, 200, 300, 400, 500, 600, 700 and 800 with the display panel, the touch display panel can be light and thin. For example, the substrate 110 is a color filter substrate, and taking an on cell touch display panel as an example, the color filter pattern (not shown) and the sensing series are respectively located on two opposite surfaces of the substrate 110. Now, since the surface S1 on which the sensing series is located is the touch surface, the bridge structures 124 and 524 are disposed between the optical matching stacked structures 150 and 550 and the substrate 110. Comparatively, taking an in cell touch display panel as an example, the color filter pattern and the sensing series are all located at a same side of the surface S1 of the substrate 110, and the sensing series is, for example, disposed between the color filter pattern and the surface S1. Now, since the surface S2 is the touch surface, the optical matching stacked structures 150 and 550 are disposed between the substrate 110 and the bridge structures 124 and 524.

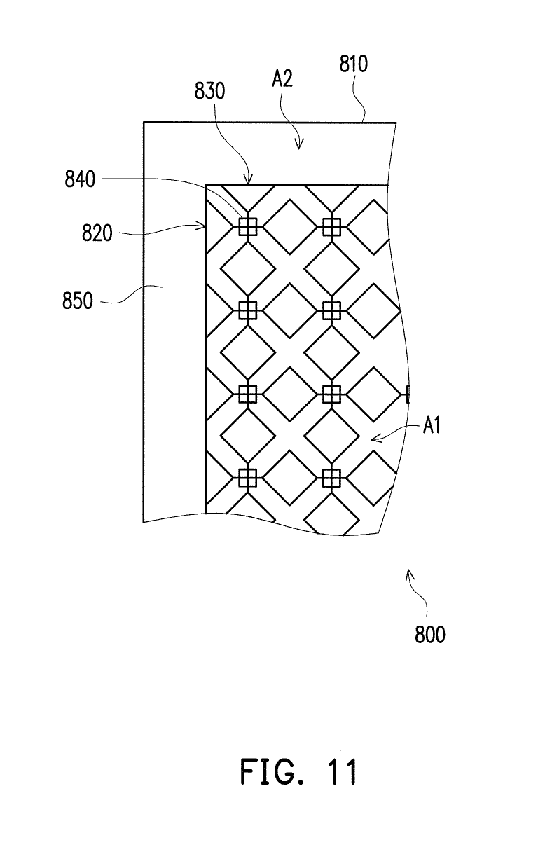

FIG. 11 is a partial top view of a touch panel according to a ninth embodiment of the invention. Referring to FIG. 11, the touch panel 800 of the present embodiment includes a substrate 810, a plurality of first sensing series 820 and a plurality of second sensing series 830, wherein the substrate 810 may serve as a cover lens. Namely, in an actual operation, the first sensing series 820, the second sensing series 830 and an insulating layer 840 are located on an inter surface of the substrate 810, and the user touches an outer surface of the substrate 810. In detail, the substrate 810 has a touch area A1 and a periphery area A2 located to at least one side of the touch area A1, and the first sensing series 820 and the second sensing series 830 are located in the touch area A1. In the present embodiment, the first sensing series 820 and the second sensing series 830 may adopt a configuration relationship of the similar components in any one of the first to the eighth embodiments, and the touch panel 800 of the present embodiment may include an insulating layer 840 to electrically insulate the first sensing series 820 and the second sensing series 830. Moreover, the touch panel 800 of the present embodiment may selectively include the aforementioned extinction layer (not shown) to improve the visual effect of the touch panel 800.

A difference between the present embodiment and the aforementioned embodiment is that the touch panel 800 of the present embodiment further includes a decoration layer 850, wherein the decoration layer 850 is located in the periphery area A2. In detail, the decoration layer 850 is, for example, used for shielding signal transmission lines or light shielding devices (not shown) located in the periphery area A2. In other words, touch devices can be configured in the periphery area A2 according to a design requirement.

In the present embodiment, the decoration layer 850 is, for example, located on the substrate 810 at a same side with that of the first sensing series 820 and the second sensing series 830. Especially, the decoration layer 810 is disposed on the inner surface of the substrate 810 and located in the periphery area A2. On the other hand, the first sensing series 820 and the second sensing series 830 are disposed on the inner surface of the substrate 810. In other embodiments, the decoration layer 850 can also be disposed on the substrate 810 at a side opposite to that of the first sensing series 820 and the second sensing series 830, i.e. the decoration layer 850 can be disposed on the outer surface (the touch surface) of the substrate 810. Moreover, in other embodiments, the touch panel 800 may further include a carrier board (not shown), wherein the decoration layer 850 is disposed on the carrier board and faces to the substrate 810, and carrier board is adhered to the substrate 810 corresponding to the periphery area A2 of the substrate 810. In other words, after the carrier board is bonded to the substrate 810, the decoration layer 850 is disposed between the substrate 810 and the carrier board, wherein an orthogonal projection of the decoration layer 850 on the substrate 810 is located in the periphery area A2.

In summary, in the touch panel of the invention, the optical matching stacked structures are disposed on the surface of the bridge structures that faces to the user, and the optical parameters (including the extinction coefficients and the refractive indexes) of the optical matching stacked structures are designed to mitigate the problem of high reflectivity of light in areas where the bridge structures are located. In this way, when the light irradiates the touch panel, the difference between reflectivity of the light at an area where the bridge structures are located and reflectivity of the light at an area without the bridge structures can be decreased, so as to achieve a good visual effect of the touch panel.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch panel, comprising:
a substrate;
a plurality of first sensing series, disposed on the substrate, wherein each of the first sensing series extends along a first direction, each of the first sensing series comprises a plurality of first sensing pads and a plurality of bridge structures, and each of the bridge structures connects two adjacent first sensing pads along the first direction;
a plurality of second sensing series, electrically insulated from the first sensing series, and disposed on the substrate, wherein each of the second sensing series extends along a second direction, the first direction is intersected to the second direction, each of the second sensing series comprises a plurality of second sensing pads and a plurality of connection portions, and each of the connection portions connects two adjacent second sensing pads along the second direction; and
a plurality of optical matching stacked structures, each disposed on a surface of each of the bridge structures that faces to a user so as to reduce a reflectivity of light along a direction of view in areas where the bridge structures are located, wherein each of the optical matching stacked structures comprises a first optical matching pattern and a second optical matching pattern, and the second optical matching pattern is disposed between the first optical matching pattern and the bridge structure.

2. The touch panel as claimed in claim 1, wherein each of the optical matching stacked structures is disposed between the substrate and one of the bridge structures.

3. The touch panel as claimed in claim 1, wherein an extinction coefficient of the first optical matching pattern is k1, a refractive index thereof is n1, and 0.2*n1<k1<2*n1, and an extinction coefficient of the second optical matching pattern is k2, a refractive index thereof is n2, and k2<0.05*n2.

4. The touch panel as claimed in claim 1, further comprising an insulating layer, wherein the insulating layer is disposed between the first sensing series and the second sensing series.

5. The touch panel as claimed in claim 4, wherein the bridge structures and the optical matching stacked structures are disposed between the insulating layer and the substrate, and each of the connection portions crosses over the corresponding bridge structure to electrically connect two adjacent second sensing pads.

6. The touch panel as claimed in claim 4, wherein each of the first optical matching patterns is disposed on the substrate, the second optical matching pattern covers the first optical matching pattern and the substrate, each of the bridge structures is disposed between the insulating layer and the second optical matching pattern, and each of the connection portions crosses over the corresponding bridge structure to electrically connect two adjacent second sensing pads.

7. The touch panel as claimed in claim 4, wherein the connection portions are disposed between the insulating layer and the substrate, wherein each of the optical matching stacked structures crosses over the corresponding connection portion, and each of the bridge structures covers one of the optical matching stacked structures.

8. The touch panel as claimed in claim 1, further comprising an extinction layer, wherein the first sensing series and the second sensing series are disposed between the extinction layer and the substrate.

9. The touch panel as claimed in claim 1, further comprising an extinction layer, wherein the first sensing series and the second sensing series are disposed between the extinction layer and the second optical matching patterns.

10. The touch panel as claimed in claim 1, further comprising an extinction layer covering the substrate, and disposed between the substrate and the first sensing series and between the substrate and the second sensing series.

11. The touch panel as claimed in claim 1, wherein a sidewall of each of the bridge structures is aligned with a sidewall of the optical matching stacked structure.

12. The touch panel as claimed in claim 1, wherein each of the bridge structures comprises a first pattern, and a material of the first pattern comprises gold, silver, copper, aluminium, chromium, platinum, rhodium, molybdenum, titanium, nickel, indium, tin, or alloys thereof, or at least one of nitride, oxide, nitrogen oxide of the above metals, or the first pattern is a multilayer-stacked conductive layer, and a material of the conductive layer comprises at least two of the above materials.

13. The touch panel as claimed in claim 12, wherein each of the bridge structures comprises a second pattern disposed between the first pattern and the corresponding optical matching stacked structure.

14. The touch panel as claimed in claim 13, wherein an extinction coefficient of the second pattern is the same to the extinction coefficient of the first optical matching pattern, and a refractive index of the second pattern is the same to the refractive index of the first optical matching pattern.

15. The touch panel as claimed in claim 12, wherein each of the bridge structures further comprises a third pattern disposed on the first pattern, and the first pattern is disposed between the third pattern and the corresponding optical matching stacked structure.

16. The touch panel as claimed in claim 1, wherein a sidewall of each of the optical matching stacked structures is wrapped by the bridge structure.

17. The touch panel as claimed in claim 1, wherein a light transmittance of each of the optical matching stacked structure is greater than 30%.

18. The touch panel as claimed in claim 1, wherein the reflectivity of light in areas where the bridge structures are located is smaller than 20%.

19. The touch panel as claimed in claim 1, wherein when a film thickness of each of the first optical matching pattern is between 140 Å and 160 Å, and a film thickness of each of the second optical matching pattern is between 480 Å and 520 Å, the reflectivity of light in areas where the bridge structure is located is smaller than 10%.

20. The touch panel as claimed in claim 1, wherein each of the first sensing pads is disposed between one of the optical matching stacked structures and the substrate.

21. The touch panel as claimed in claim 1, wherein a sidewall of each of the bridge structures is covered and contacted by the corresponding first sensing pads.

22. The touch panel as claimed in claim 1, wherein a light transmittance of each of the optical matching stacked structures is greater than a light transmittance of each of the bridge structures.

23. The touch panel as claimed in claim 1, wherein a material of the first sensing pad and the second sensing series comprises indium tin oxide, indium zinc oxide, aluminium tin oxide, aluminium zinc oxide or indium germanium zinc oxide, or the first sensing pad and the second sensing series are respectively composed of metal mesh, or the first sensing pad and the second sensing series are respectively a multilayer-stacked conductive layer, and a material of the conductive layer comprises at least two of indium tin oxide, indium zinc oxide, aluminium tin oxide, aluminium zinc oxide, indium germanium zinc oxide and metal mesh.

24. The touch panel as claimed in claim 1, wherein each of the first sensing pads and each of the second sensing series are respectively composed of metal mesh, and the optical matching stacked structures are further disposed on a surface of the first sensing pads and the second sensing series that faces to the user.

25. The touch panel as claimed in claim 1, wherein the substrate has a touch area and a periphery area located to at least one side of the touch area, and the touch panel further comprises a decoration layer located in the periphery area.

26. The touch panel as claimed in claim 25, wherein the decoration layer is located on the substrate at a side the same to that of the first sensing series and the sensing series.

27. The touch panel as claimed in claim 25, wherein the decoration layer is located on the substrate at a side opposite to that of the first sensing series and the sensing series.

28. The touch panel as claimed in claim 25, further comprising a carrier board, wherein the carrier board is located on the substrate at a side opposite to that of the first sensing series and the sensing series, and the decoration layer is disposed on the carrier board, and is disposed between the substrate and the carrier board, wherein an orthogonal projection of the decoration layer on the substrate is located in the periphery area.

29. The touch panel as claimed in claim 1, wherein the substrate is a color filter substrate, an array substrate or a package cover of an organic light-emitting display.
